(19) United States
(12) Patent Application Publication
(10) Pub. No.: US 2013/0110658 A1
(43) Pub. Date: May 2, 2013

(54) SYSTEMS AND METHODS FOR ENABLING MOBILE PAYMENTS

(71) Applicants: Daniel J. Lyman, Haymarket, VA (US); Kevin J. Gatesman, Fairfax, VA (US); Robert H. Chase, Herndon, VA (US); Rajeev P. Veettil, Aldie, VA (US); Luc H. Saraka, Ashburn, VA (US)

(72) Inventors: Daniel J. Lyman, Haymarket, VA (US); Kevin J. Gatesman, Fairfax, VA (US); Robert H. Chase, Herndon, VA (US); Rajeev P. Veettil, Aldie, VA (US); Luc H. Saraka, Ashburn, VA (US)

(73) Assignee: TRANSACTION NETWORK SERVICES, INC., Reston, VA (US)

(21) Appl. No.: 13/466,044

(22) Filed: May 7, 2012

Related U.S. Application Data
(60) Provisional application No. 61/482,755, filed on May 5, 2011.

(51) Int. Cl. G06Q 20/36

(52) U.S. Cl. CPC G06Q 20/3674
USPC 705/18; 705/41

(57) ABSTRACT

Systems, devices, and methods for processing payment transactions are provided. In some embodiments, payment account information is stored in a mobile wallet by a configuration portal server, and payment tokens are transmitted to a mobile device. A payment token may be submitted by the mobile device to a merchant point-of-sale device as part of a transaction. The payment token may be transmitted to a mobile wallet registry system, which may use the payment token to obtain the payment account information or otherwise complete the transaction. In some embodiments, more than one payment account may be stored in a mobile wallet, and more than one payment account may be associated with a given payment token.

### CROSS-REFERENCE TO RELATED APPLICATION

This application claims the benefit of U.S. Provisional Application No. 61/482,755, filed May 5, 2011, the entirety of which is incorporated herein by reference for all purposes.

### BACKGROUND

Mobile devices such as cell phones, smart phones, and/or the like are being used increasingly to pay for goods and services. Systems have been created that allow a consumer to pay for a point-of-sale transaction using a mobile device. However, as mobile devices are highly susceptible to loss or theft, mobile device provisioning and software systems are vulnerable to hackers, and securing sensitive payment details on mobile devices involves complex and costly processes, it is not desirable to store payment information on the mobile device. In addition, merchants incur costs to maintain compliance with data security best practices when they handle cardholder details, and they can reduce their data breach liability risk by reducing or eliminating the need to process, store, or transmit payment account details. Merchants also desire a substantially uniform set of processes at the point-of-sale to normalize the acceptance of mobile payments from a variety of mobile payment providers, payment methods, mobile device wallet applications, and/or the like. What is needed is a system that allows consumers to use mobile devices to make payments using payment accounts enabled for use by mobile device applications, all while preserving the security of the consumer's payment account information and providing the merchant with a unified and secure payment process regardless of underlying payment type, mobile device type, or payment application provider.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computing device configured to perform actions for processing a payment authorization request is provided. The actions comprise receiving, by the computing device from a merchant point-of-sale device, a payment authorization request, wherein the payment authorization request includes a payment token; transmitting, by the computing device, a validation request to a mobile token validation module; receiving, by the computing device, payment account information from the mobile token validation module in response to the validation request; transmitting, by the computing device to a payment processor, a payment authorization request based on the payment account information; and transmitting, by the computing device to the merchant point-of-sale device, a payment authorization response, the payment authorization response including a persistent token.

In some embodiments, a system for managing mobile tokens is provided. The system comprises a mobile token data store and a mobile token validation module. The mobile token data store is configured to store token records, each token record including a mobile token and an associated wallet identifier. The mobile token validation module is communicatively coupled to the mobile token data store, and is configured to receive a validation request from a requestor, the validation request including a mobile token and a payment type indication; retrieve a wallet identifier associated with the mobile token from a token record in the mobile token data store; retrieve payment account information from a configuration portal server using the mobile token and the payment type indication; and transmit the payment account information to the requestor.

In some embodiments, a computer-implemented method for configuring and using a mobile wallet is provided. The method comprises receiving, by a configuration portal server, a wallet boarding request from a requesting device, wherein the wallet boarding request includes a mobile device identifier; creating, by the configuration portal server, a sponsor wallet in a sponsor wallet data store, the sponsor wallet including payment type information, payment account information, and the mobile device identifier; transmitting, by the configuration portal server, policy setting information and payment type information to a mobile wallet registry system; receiving, by the configuration portal server, a wallet identifier from the mobile wallet registry system; and storing, by the configuration portal server, the wallet identifier in the sponsor wallet.

In some embodiments, a system for managing mobile tokens is provided. The system comprises a mobile token data store and a mobile token validation module. The mobile token data store is configured to store token records, each token record including a mobile token and an associated wallet identifier. The mobile token validation module is communicatively coupled to the mobile token data store and is configured to receive a validation request from a requestor, the validation request including a mobile token and a payment type indication; retrieve a wallet identifier associated with the mobile token from a token record in the mobile token data store; transmit the wallet identifier to a configuration portal server; receive a validation response created by an issuer processor system of the configuration portal server; and transmit the validation response to the requestor.

In some embodiments, a mobile device configured to use a mobile wallet is provided. The mobile device comprises one or more sponsor applications and a service application. The service application is configured to receive a request from a sponsor application to use a payment token associated with a payment type; verify that the sponsor application is authorized to use the requested payment type; and in response to determining that the sponsor application is authorized, provide the requested payment token for use by the sponsor application.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an exemplary embodiment of a mobile wallet registry system according to various aspects of the present disclosure;

FIG. 2 illustrates an exemplary embodiment of a method for configuring a mobile wallet, according to various aspects of the present disclosure;

FIG. 3 illustrates an exemplary embodiment of a method for generating a payment token, according to various aspects of the present disclosure;

FIGS. 4A and 4B illustrate an exemplary embodiment of a method for processing a point-of-sale transaction according to various aspects of the present disclosure;

FIG. 5 illustrates another exemplary embodiment of a mobile wallet registry system according to various aspects of the present disclosure;

FIG. 6 illustrates yet another exemplary embodiment of a mobile wallet registry system according to various aspects of the present disclosure; and

FIG. 7 illustrates another exemplary embodiment of a method for processing a point-of-sale transaction according to various aspects of the present disclosure.

### DETAILED DESCRIPTION

While some existing systems may associate payment account details with tokens after payment account details are provided to merchant payment acceptance systems, embodiments of the approach disclosed herein allow mobile devices and merchant point-of-sale systems to avoid ever handling actual payment account details. In one aspect, embodiments of the present disclosure provide at least a mobile wallet registry system that allows integration between a mobile wallet provided by a mobile device with a point-of-sale system and a traditional payment processing infrastructure. Payment account details remain secure “in the cloud,” and a lost or compromised mobile device may be rendered practically meaningless from a payments fraud risk perspective through a combination of payment token policies, layers of separation from the actual payment account details, and user verification.

In embodiments of the present disclosure, payment account information is tokenized for mobile payments prior to a consumer transaction, so that there is no actual payment account information on the mobile device or introduced into the merchant's systems at the time of the transaction. One benefit of embodiments of the present disclosure may be the reduction of risk to merchants of data breach and the scope of their PCI-DSS compliance requirements. Another benefit to consumers and their account issuers may be that actual payment account information is not present on the mobile device, even in encrypted or securely stored formats. The elimination of sensitive payment account information from both the mobile device and the merchant enterprise may virtually eliminate the risk of data breach at the consumer or merchant level.

The payment token may have a narrower scope of risk than a payment card or credit card, since tokens have a limited time-to-live and single or limited use as inherent security characteristics. In addition, sponsor applications may, for example, require additional security characteristics such as user authentication (e.g., requiring a user password, challenge question/response, account information, biometric verification, a PIN, and/or the like) to access the sponsor application at the point-of-sale or to request additional tokens, and predetermined security policies (e.g., spending limits, enumerated or limited merchant types, and/or the like). In some embodiments of the present disclosure, a sponsor may be an entity having a relationship with the consumer, and some embodiments may involve a single sponsor or multiple sponsors.

Some embodiments of the present disclosure are characterized by certain properties. One such property may be neutrality. Such an embodiment enables secure mobile payments while enabling platform constituents (such as merchants, payment card schemes, payment card issuers, alternative payment providers, mobile carriers, acquirers, processors, and/or the like) to differentiate their services and control their customers' experiences by managing their own mobile applications that leverage the seamless and secure infrastructure disclosed herein.

Another property may be adoptability. Embodiments of the present disclosure maximize transparency with regard to how card payments are currently authorized and settled at the point-of-sale. The existing payments authorization and settlement infrastructure are leveraged by embodiments of the present disclosure to accommodate secure mobile wallet-based payments. In addition, the proposed mechanisms are consistent with emerging proximity payment methods at the point-of-sale, including near-field communications, barcodes, QR codes, audio signals, and the like. In one embodiment, the security mechanisms do not require the mobile device to be connected to a network to consummate a transaction at the point-of-sale. Further, embodiments of the present disclosure may help alternative payment providers, such as PayPal, Google Checkout, and/or the like to enter brick and mortar point-of-sale markets by allowing such alternative payment service providers to integrate with existing point-of-sale and payment acceptance infrastructure. The tokenization system disclosed herein may intermediate between other electronic payment systems, such as those cited here, as a trusted security proxy for the exchange of transaction information and information regarding the consumer.

Yet another property may be utility. Embodiments of the present disclosure offer a low-level utility that may be leveraged by third parties to achieve more secure, seamless, and homogeneous payments across devices, networks, tender types, and/or the like. It may be offered as a discrete service, or may be bundled within service offerings that make up other parts of the end-to-end infrastructure.

Another property may be flexibility. The proposed authorization security may be implemented by third parties in a number of ways, and may allow constituents to manage their own business risk by establishing customized thresholds and use limitations. Scenarios wherein a wireless carrier embeds or installs software on its mobile devices prior to distribution, as well as scenarios where the consumer downloads one or more applications to a previously activated mobile device, as well as hybrids of these approaches, can be supported.

In some embodiments, a mobile wallet registry system as disclosed herein may support “front-end” and/or “back-end” integration scenarios. In a front-end scenario, tokens are resolved to the underlying payment account information via a technical integration with a merchant, a merchant processor or service provider, a payment gateway, a merchant acquirer, and/or the like (i.e., the technical integration is with a system performing payment gateway actions). In a back-end scenario, tokens are resolved to the underlying payment account information via a technical integration with a payment processor acting on behalf of an issuer of the payment service to the consumer. Hybrid approaches incorporating elements of these two models can also be supported. For example, a hybrid scenario that involves the issuer or consumer payment service provider acting as a consumer sponsor in a front-end integration scenario is discussed further below.

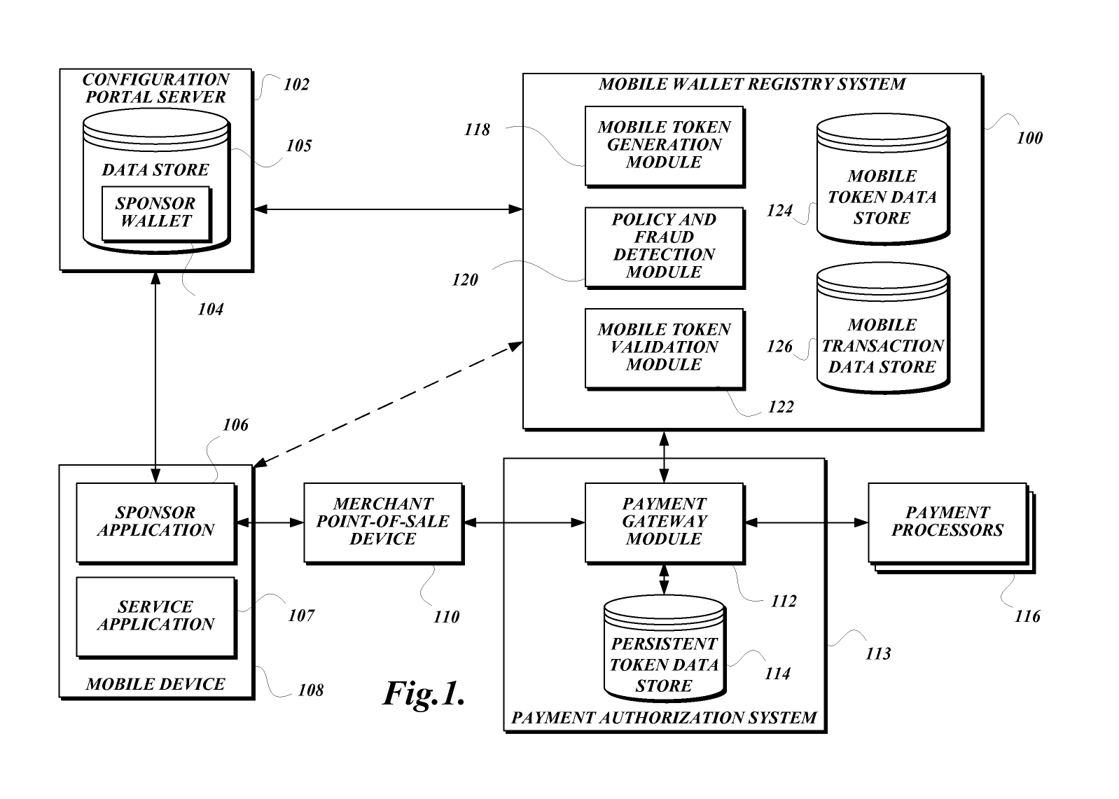

FIG. 1 illustrates an exemplary embodiment of a mobile wallet registry system 100 according to various aspects of the present disclosure. The illustrated mobile wallet registry system 100 in FIG. 1 is configured in a front-end integration scenario. A mobile wallet registry system 100 registers and maintains references to mobile wallets; generates, validates, and distributes payment tokens; and captures transaction details that may be made available to merchants and/or their service providers for reconciliation and marketing purposes.

A configuration portal server 102 is provided by a party that owns a relationship with a consumer for enabling a mobile payments capability, such as a merchant, a pre-paid or gift card provider, a card issuer, a telecommunications company, a bank, an alternative payment service provider (such as PayPal and/or the like), an independent mobile wallet application provider, and/or the like. The configuration portal server 102 stores a sponsor wallet 104 that is associated with the customer and stores payment information associated with the customer. In some embodiments, a single configuration portal server 102 may be associated with each sponsor application 106 on the mobile device 108. In some embodiments, multiple configuration portal servers 102 operated by multiple sponsoring parties each having a relationship with the consumer may enable specific payments capabilities within one or more sponsor applications 106 on the mobile device 108.

A mobile device 108 is any portable electronic device capable of storing and conveying tokens that indirectly represent payment information, such as a smart phone, a feature phone, a cell phone, a netbook, a laptop computer, a PDA, a personal media player, a gaming system, a tablet, a dedicated mobile wallet computing device, and/or the like.

The mobile device 108 hosts a sponsor application 106. In one embodiment, the sponsor application 106 includes a software and/or hardware subsystem configured to store, manage, and convey tokens that indirectly represent payment information. In some embodiments, the sponsor application 106 may present the token to an authenticated user. In some embodiments, multiple sponsor applications 106 may reside on a single mobile device 108, each linked to a separate configuration portal server 102 and/or a separate sponsor wallet 104. In some embodiments, one or more sponsor applications 106 that reside on a single mobile device 108 may each be associated with multiple configuration portal servers 102 and/or multiple sponsor wallets 104 via functions performed by a service application 107. As indicated by the dashed arrow, in some embodiments, the mobile device 108 may communicate directly with the mobile wallet registry system 100 instead of communicating through the configuration portal server 102 and/or the merchant point-of-sale device 110 to access various functionality described herein.

A merchant point-of-sale device 110 is provided to receive a payment token from the mobile device 108, and to transmit a payment authorization request. As illustrated, the payment authorization request is transmitted to a payment gateway module 112 of a payment authorization system 113. In the embodiment illustrated in FIG. 1, the payment authorization system 113 may include transaction switching and communications infrastructure that connects the merchant point of sale device 110 to the payment processors 116 without regard to the business entities operating the infrastructure. In some embodiments, the payment gateway module 112 may be a part of the merchant's data communications and switching environment or a part of a payment processor 116 instead of a part of the illustrated third-party payment authorization system 113. The merchant point-of-sale device 110 may be any type of device configured to accept payment information on behalf of the merchant in order to submit payments for authorization and settlement. For example, in some embodiments, the merchant point-of-sale device 110 may include a point-of-sale device similar to a cash register or a stand-alone payment terminal at a physical store. In some embodiments, the merchant point-of-sale device 110 may include a web server configured to present a web-based payment interface. In some embodiments, the merchant point-of-sale device 110 may include a mobile device configured to execute an application for accepting payment information.

The payment gateway module 112 is configured to detect that the authorization request includes a token, retrieve payment information from the mobile wallet registry system 100, and transmit it to a payment processor 116 such as a traditional merchant acquirer processor, an automated clearinghouse, an alternative payments provider, an issuer processor, and/or the like, for processing. In some embodiments, the payment gateway module 112 may also create or receive a persistent token to store persistent information associated with a given sponsor wallet 104, a given consumer payment account within the sponsor wallet 104, or a specific transaction. In some embodiments, the sponsor application 106 may format the mobile token in a manner such that, once passed to the merchant point-of-sale device 110, it may be used as a persistent or semi-persistent reference for the transaction. In some embodiments, the persistent token and/or the mobile token may be stored in a persistent token data store 114.

To briefly describe some aspects of roles of each of these elements, the configuration portal server 102 provides at least a software portal that enables the creation, maintenance, and elimination of consumer wallets and/or payment methods available for use within those wallets. In some embodiments, the configuration portal server 102 may request from the mobile wallet registry system 100 that payment tokens be distributed to mobile devices 108 for use by sponsor applications 106. In some embodiments, the sponsor party operating the configuration portal server 102 may simply be a wallet provider, and may provide functionality through the configuration portal server 102 merely as described herein. In some embodiments, the sponsor may have a more complex relationship with the customer, such as a bank or credit issuer, a wireless service provider, a merchant, a prepaid or gift account provider, an alternative payment service provider, and/or the like. In these embodiments, the configuration portal server 102 may also provide further services to the customer related to their relationship with the sponsor, such as wireless account management, online banking, loyalty benefits, targeted offers, and/or the like.

In some embodiments, the sponsor application 106 may request payment tokens directly from the mobile wallet registry system 100. In some embodiments, a service application 107 on the mobile device 108 may request and manage the acceptance and storage of mobile tokens in conjunction with the mobile wallet registry system 100. In such embodiments, the service application 107 manages the availability of tokens to one or more sponsor applications 106. Tokens accessible by more than one sponsor application 106 may be managed by the service application 107. In such cases, the service application 107 may be configured to ensure that sponsor applications 106 are only provided access to stored tokens and/or payment types for which the sponsor applications 106 are authorized, even when all tokens on the mobile device 108 are associated with the same wallet ID. For example, the service application 107 may grant access to a token associated with a general purpose payment type, such as a major credit card, to a broad range of authorized sponsor applications 106 requesting use of tokens associated with that payment type. Meanwhile, the service application 107 may restrict access to a token associated with a limited purpose payment type, such as a private label payment account associated with a given retailer, a gift card account for a given retailer, and/or the like, to authorized sponsor applications 106 associated with the given retailer. The service application 107 may determine which sponsor applications 106 have access to which tokens and/or payment types using any suitable technique, such as access codes associated with the tokens, payment types represented by the tokens, and/or the like.

The mobile wallet registry system 100 works in conjunction with one or more configuration portal servers 102 to register and maintain references to one or more sponsor wallets 104. In the discussion herein, the references may be referred to as wallet identifiers or wallet IDs. In some embodiments, the mobile wallet registry system 100 maintains wallet IDs, mobile device identifiers (e.g. mobile telephone numbers, internet addresses, electronic serial numbers, and/or the like), and available payment types associated with each sponsor wallet 104. In some embodiments, a single wallet ID may be associated with multiple sponsor wallets 104. For example, a given mobile device 108 and/or a given wallet ID may be associated with more than one sponsor wallet 104, such as a first sponsor wallet 104 associated with a first configuration portal server 102 and a second sponsor wallet 104 associated with a second configuration portal server 102, and/or the like.

The mobile wallet registry system 100 authenticates requests for tokens (either “push” requests from the configuration portal server 102 or “pull” requests from the sponsor application 106 or service application 107 resident on the mobile device 108) and generates one-time or limited-use payment tokens that are distributed to the mobile device 108 to be made available for use by one or more sponsor applications 106. In some embodiments, the mobile wallet registry system 100 can autonomously manage the distribution of mobile tokens to the applications on the mobile device 108 after one or more sponsor wallets 104 have been configured via the configuration portal server 102. In some embodiments, the mobile device 108 receives the payment tokens from the mobile wallet registry system 100 over an air interface such as a WiFi network, a wireless telephone or wide area data network such as 3G or 4G, a direct physical connection to a networked computing device, and/or the like. In some embodiments, the tokens may be generated by the mobile wallet registry system 100 and passed to the sponsor operating the configuration portal server 102 for distribution to the mobile device 108 via an air interface such as the air interface as described above. Authentication of the consumer for enrollment with the configuration portal server 102 and with the sponsor application 106 on the mobile device 108 may be managed by the configuration portal server 102 and the sponsor application 106 by the sponsor entity (or entities) managing those systems, and may not involve the mobile wallet registry system 100.

At the merchant point-of-sale device 110, a token associated with a specific wallet ID and an enabled payment type stored in a sponsor wallet 104 is passed from the mobile device 108 to the merchant point-of-sale device 110 by any suitable method, such as via near-field communication methods (e.g., standard NFC or RFID), barcode scan, QR code scan, Bluetooth, WiFi, acoustic frequency tones, manual entry into an interface presented by the merchant point-of-sale device 110, internal communication between a shopping interface and an API provided by the merchant point-of-sale device 110, and/or the like. In one embodiment, the token is “format preserving,” in that it appears to the merchant point-of-sale device 110 to be any other standard type of payment card. This may allow the mobile wallet registry system 100 to be used to process payment transactions without requiring updates or reconfigurations of legacy merchant point-of-sale devices 110, especially if the legacy merchant point-of-sale device 110 is already configured to accept other payment information via contactless or other proximity payment techniques. In some embodiments, the communication from the mobile device 108 to the merchant point-of-sale device 110 is unidirectional, and therefore the mobile device 108 provides information to the merchant point-of-sale device 110 but does not obtain information about the transaction at the time of the transaction from the merchant point-of-sale device 110. In some embodiments, the communication between the mobile device 108 and the merchant point-of-sale device 110 is bidirectional, and therefore the mobile device 108 may obtain transaction information directly from the merchant point-of-sale device 110 to help enable richer functionality within the sponsor application 106 such as electronic receipting; prepaid or gift balance notification; couponing; detailed transactional data such as purchase itemizations; automatic selection of the payment type or denial of the transaction based on the merchant, merchant category, transaction amount, or other transaction-specific characteristics; evaluation of other transaction information by the mobile device 108, the sponsor application 106, or the service application 107; and/or the like.

After receiving the payment token, the merchant point-of-sale device 110 creates an authorization request. In the embodiment illustrated in FIG. 1, the authorization request is sent for authorization to the payment gateway module 112. Communication between the merchant point-of-sale device 110 and the payment gateway module 112 may occur via any suitable public or private communication network or technology, such as via a wired or wireless LAN, WAN, leased-line network, the Internet, public-switched telephone network connection, and/or the like. In some embodiments, the payment gateway module 112 recognizes the token as being a token associated with the mobile wallet registry system 100 (as opposed to payment details to be sent directly to a payment processor 116), suspends the authorization request process, and requests payment details associated with the token from the mobile wallet registry system 100. Communication between the payment gateway module 112 and the mobile wallet registry system 100 may also occur via any suitable public or private communication network or technology, such as via a LAN, WAN, leased-line network, the Internet, and/or the like. After policy and fraud validation, the mobile wallet registry system 100 obtains the payment details associated with the token from the sponsor wallet 104 at the appropriate configuration portal server 102. The payment details are then returned to the payment gateway module 112, which resumes the authorization request by transmitting the information to a payment processor 116, such as in a legacy system. While the payment tokens may be configured for one-time use or limited use, the payment gateway module 112 may generate a persistent token that is returned to the merchant point-of-sale device 110 along with a payment authorization response. The persistent token, if different from the token used to originate the authorization request, may be used in the future by the merchant to enable, for example, refunds, reconciliations, consumer patterning, marketing purposes, and/or the like.

The mobile wallet registry system 100 may include a mobile token generation module 118, a policy and fraud detection module 120, a mobile token validation module 122, a mobile token data store 124, and a mobile transaction data store 126. The policy and fraud detection module 120 is configured to enforce wallet policies, which may include, but are not limited to, a pre-set spending limit per token, a token expiration date/time, a token window (a number of outstanding/unused tokens assigned to a mobile device at a given time), allowable merchants or merchant categories, token velocity of use or requests (a frequency and/or location of token use or requests), and the like. The policy and fraud detection module 120 may also monitor for fraud patterns, such as frequent token requests, geographic disparities, and/or the like.

The mobile token generation module 118 is configured to generate new tokens for a mobile device 108. The mobile token data store 124 is configured to store token records that include mobile tokens, associated wallet IDs, associated available payment types, addressing information (e.g., mobile phone numbers), associated policy settings, and/or the like. The mobile token validation module 122 is configured to validate a mobile token at the time of purchase, to retrieve the wallet ID associated with a valid token from the mobile token data store 124, and to provide the wallet ID to the appropriate configuration portal server 102 so that the payment account information may be retrieved from the sponsor wallet 104.

The mobile transaction data store 126 is configured to store information about the transactions such as date/timestamps, message types, transaction amounts and other details that may be available from the authorization request, merchant IDs, merchant categories, and/or the like. The stored information may be accessed by merchants or their service providers to enhance direct mobile marketing efforts and/or for any other suitable purpose.

In some embodiments, the mobile wallet registry system 100 may be configured to transmit transaction information, such as a merchant identifier, a transaction amount, and/or the like, to the configuration portal server 102 along with the request for payment account information. This may allow the sponsor managing the configuration portal server 102 to choose between multiple payment accounts associated with the wallet ID (as opposed to the sponsor application 106 defining the specific payment type). As one example, the configuration portal server 102 may provide payment account information from a first account for transactions less than or equal to a threshold amount, and may provide payment account information from a second account for transactions greater than the threshold amount. Though not illustrated, the mobile wallet registry system 100 may also provide a fraud alert capability that transmits a notification to the appropriate configuration portal server 102 when potential fraud is detected to allow the sponsor associated with the configuration portal server 102 to react accordingly. The mobile wallet registry system 100 may also provide a transaction status data feed to the configuration portal server 102 that provides data about transactions that were conducted within a given time period.

Each of the servers, systems, and devices described above may be a physical computing device configured to provide the specified features. For example, in one embodiment, the configuration portal server 102 and/or the mobile wallet registry system 100 may be a server computer having a processor, a memory, a network controller, and a tangible computer readable storage medium. In other embodiments, one or both of these components may be any other suitable computing device, such as a desktop computer, an embedded computing device, a cloud computing service executing on one or more server computers, a laptop computer, and/or the like. In one embodiment, each of the modules described herein includes computer executable instructions stored on a tangible computer readable medium that, in response to execution by a processor of a computing device, cause the computing device to perform the actions described as associated with the module. In another embodiment, a module may be a physical computing device specially programmed to perform the described actions. The modules may each be provided by the same device, or may be provided by devices that are communicatively coupled to one another.

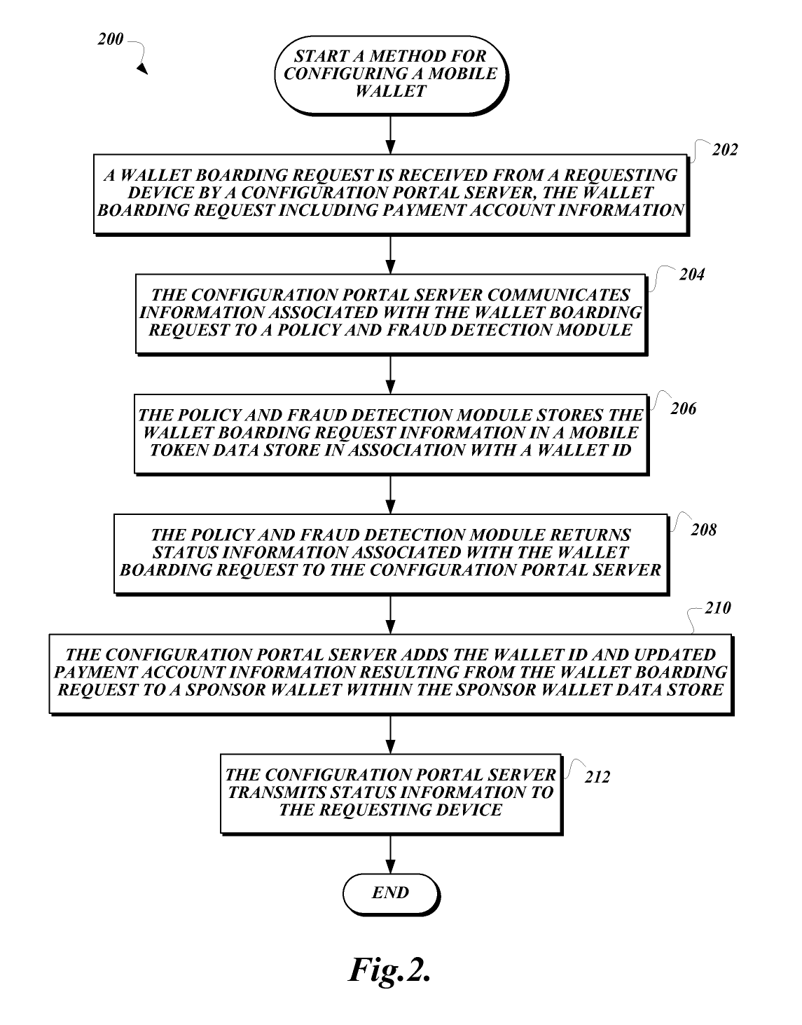

FIG. 2 illustrates one embodiment of a method for configuring a mobile wallet, according to various aspects of the present disclosure. From a start block, the method 200 proceeds to block 202, where a wallet boarding request is received from a requesting device, such as mobile device 108, by a configuration portal server 102. The mobile device 108 may communicate with the configuration portal server 102 wirelessly, such as via a wireless cellular wide area data network such as 3G or 4G, SMS, WiMax, WiFi, and/or the like. Alternatively, a different device such as a personal computer with an internet browser and a wired or wireless Internet connection may be used to initiate the mobile wallet configuration process. The consumer, whether using the mobile device 108 or a personal computer, is authenticated to the configuration portal server 102 using a mechanism established by the configuration portal server 102. Communication security may also be managed by the configuration portal server 102. The wallet boarding request includes payment account information, such as credit card numbers and expiration dates, bank account numbers, mobile device identifiers (e.g., mobile telephone number) and/or the like, to be stored in the sponsor wallet 104. In embodiments where the configuration portal server 102 is maintained by a payment service provider (such as an issuer of traditional credit or debit products and/or the like) that already has a relationship with the consumer, the enrollment or configuration process may not require the transmission of sensitive account information, as such information may be derived by the configuration portal server 102 based on an authenticated identity of the consumer. In some embodiments, a configuration portal server 102 may create and register one or more sponsor wallets 104 in conjunction with the mobile wallet registry system 100 in the absence of an external request from a mobile device 108 or other device.

Next, at block 204, the configuration portal server 102 communicates information associated with the wallet boarding request (such as one or more payment types, information identifying the specific mobile device 108, and policy setting details) to a policy and fraud detection module 120. The payment type associated with the wallet boarding request indicates a type of funding account and a payment service provider, but does not include sensitive payment account details such as account numbers, expiration dates, and/or the like. The policy setting information transmitted to the policy and fraud detection module 120 may apply to all payment types associated with the sponsor wallet 104, or may apply to one or more specific payment types associated with the sponsor wallet 104 as described in greater detail below. At block 206, the policy and fraud detection module 120 either creates a wallet ID or resolves an existing wallet ID associated with the specific mobile device 108, and stores the information associated with the wallet boarding request in a mobile token data store 124 in association with the wallet ID. At block 208, the policy and fraud detection module 120 returns status information associated with the wallet boarding request, including the wallet ID and updated supported payment type(s), to the configuration portal server 102. At block 210, the configuration portal server 102 adds the wallet ID and updated payment account information resulting from the wallet boarding request to a sponsor wallet 104 within the sponsor wallet data store 105. The configuration portal server 102 and the mobile wallet registry system 100 may use the wallet ID in future communications associated with managing a particular sponsor wallet 104, such as for enabling, disabling, and/or removing payment types and accounts; updating policy setting information, and/or the like.

In some embodiments, multiple different policies may be included in the policy setting information, each different policy being associated with at least one payment account for which account information is stored in the sponsor wallet 104. For example, a first payment account may be associated with a policy setting that only allows transactions under a threshold amount and only for a first category of merchants, or even at specific merchants, while a second payment account may be associated with a policy setting that does not set a threshold amount limit and only excludes transactions from the first category of merchants (thereby forcing the first payment account to be used). These policy settings are exemplary only, and should not be construed as limiting.

At block 212, the configuration portal server 212 transmits the status information to the requesting device, such as the mobile device 108 or the personal computer discussed above. In some embodiments, the sponsor application 106 may receive some or all of the policy setting information, and may use the policy information to enforce at least certain pre-transaction policy restrictions, such as token time-to-live, a PIN verification, and/or the like. In an embodiment wherein communication between the mobile device 108 and the merchant point-of-sale device 110 is bidirectional, the sponsor application 106 may provide richer token usage policy enforcement. The method 200 then proceeds to an end block and terminates.

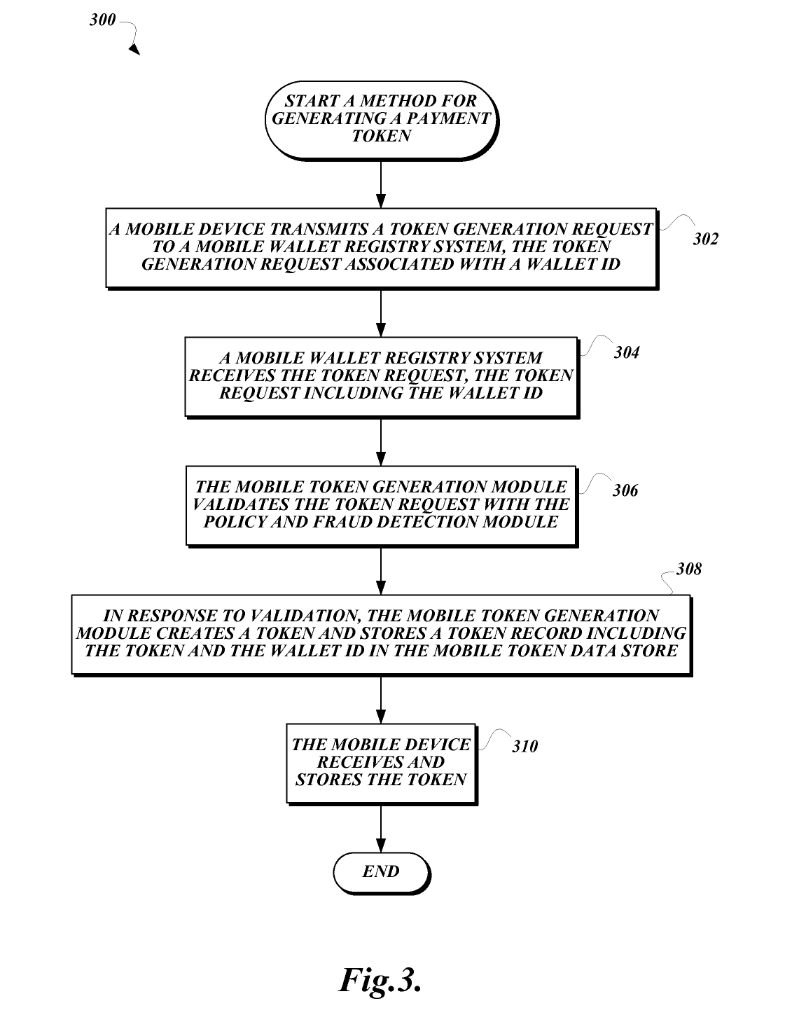

FIG. 3 illustrates an exemplary embodiment of a method 300 for generating a payment token. This illustration of the method 300 assumes that a wallet ID has been created and has been stored along with policy settings in the mobile token data store 124. The illustration also assumes that the sponsor application 106 and/or the service application 107 has been installed on the mobile device 108, and that authentication credentials for the consumer have been accepted by the sponsor application 106 or established on a communication link between the mobile device 108 and the configuration portal server 102.

In this exemplary embodiment, from a start block, the method 300 proceeds to block 302, where a mobile device 108 transmits a token generation request to a mobile wallet registry system 100, the token generation request associated with a wallet ID. At block 304, the mobile wallet registry system 100 receives a token request. In one embodiment, the token generation request may contain the wallet ID. In another embodiment, the mobile wallet registry system 100 may derive the wallet ID based on an identification of the mobile device 108 originating the request, authentication credentials associated with a communication link, and/or via any other suitable technique. In some embodiments, the mobile device 108 may transmit the token request to the configuration portal server 102, and the configuration portal server 102 may request that the mobile wallet registry system 100 generate one or more payment tokens for the wallet ID associated with the request. As before, the communication link between the mobile device 108 and the mobile wallet registry system or the configuration portal server 102 may be over any suitable communication medium, including a wireless communication network. In one embodiment, the token generation request may be created in response to receiving a request from a user. In another embodiment, the token generation request may be created automatically when a number of available tokens on the mobile device 108 drops below a threshold. In some embodiments, the monitoring of payment token availability to be used by sponsor applications 106 on mobile devices 108 may be managed centrally by the mobile wallet registry system 100 or the configuration portal server 102. In such embodiments, payment tokens may be pushed to the mobile device 108 via the component that is providing the central management of payment tokens.

Next, at block 306, the mobile token generation module 118 validates the token request with the policy and fraud detection module 120. At this point, the policy and fraud detection module 120 determines whether the token request is likely to be valid or invalid, based on a previous fraud alert, a previous suspicious activity, and/or the like. If the request is found to be invalid, the mobile token generation module 118 will take appropriate action, which may include notifying the entity managing the associated configuration portal server 102, which will take appropriate action. At block 308, in response to successful validation, the mobile token generation module 118 creates a token consistent with the policy settings associated with the wallet ID and stores a token record in the mobile token data store 124. In some embodiments, the token record includes at least the token and the wallet ID. In some embodiments, the token record may also include other information, such as a mobile device identifier, available payment types that can be associated with the token, other policies or restrictions around the use of the token, and/or the like.

The method 300 then proceeds to block 310, where the mobile device 108 receives and stores the token. In some embodiments, the token may be received directly from the mobile wallet registry system 100. In some embodiments, the token may be transmitted by the mobile wallet registry system 100 to the configuration portal server 102, and the configuration portal server 102 may transmit the token to the mobile device 108. In some embodiments, the mobile device 108 may also receive and store policy setting information, such as a time-to-live value for the token and/or the like, for future purchases. The token and associated policy setting information (where applicable) may be stored within the general memory of the mobile device 108, within a secure hardware element on the mobile device 108, or may be stored within the service application 107 or sponsor application 106. The method 300 then proceeds to an end block and terminates.

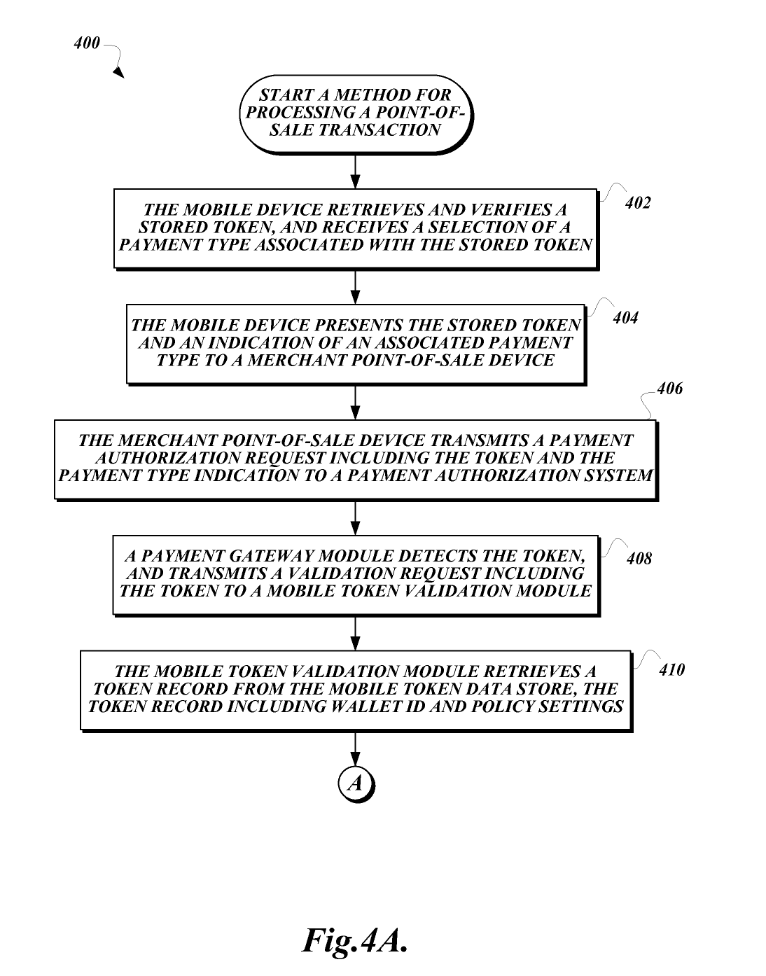

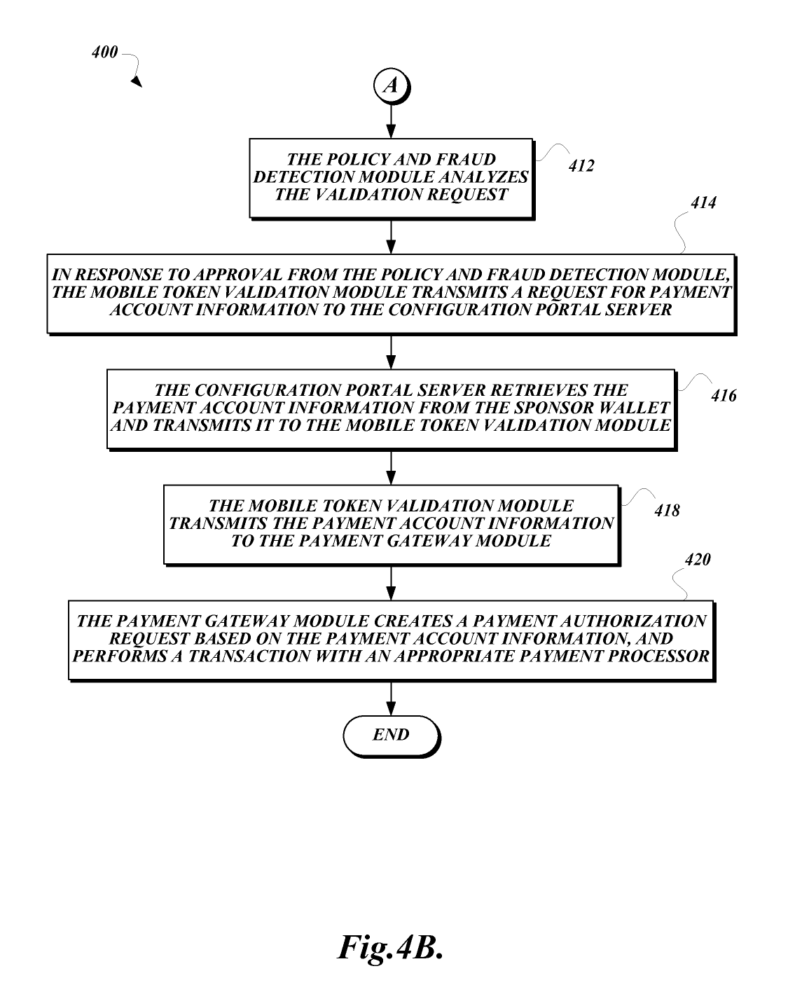

FIGS. 4A and 4B illustrate an exemplary embodiment of a method 400 for processing a point-of-sale transaction in a front-end integration scenario according to various aspects of the present disclosure. This illustration of the method 400 assumes that the wallet ID has been created, that at least one payment token has been assigned and stored on the mobile device 108, and that the merchant point-of-sale device 110 is able to accept payment data from the mobile device 108, such as via a proximity-based interface. No direct communication connection is necessary between the mobile device 108 and the configuration portal server 102 or the mobile wallet registry system 100. The sponsor application 106 may require the consumer to be authenticated to the sponsor application 106 in order to access the application, select a payment type, and use mobile tokens within the method 400.

From a start block, the method 400 proceeds to block 402, where the mobile device 108 retrieves and verifies a stored token from an internal token store. In one embodiment in which the token may be associated with more than one payment type (such as a credit card, a debit card, an electronic funds transfer, an alternative payment type, and/or the like), the mobile device 108 receives a selection of a payment type to be associated with the stored token. In some embodiments, the sponsor application 106 or service application 107 may modify or append information to the stored token to indicate a specific funding mechanism or payment type to be used for the transaction. Next, at block 404, the mobile device 108 presents the stored token and an indication of an associated payment type to a merchant point-of-sale device 110. In one embodiment, the token and indication of the associated payment type are presented via proximity-based communication, such as via a barcode displayed by the mobile device 108, a near-field communication method, and/or the like. In one embodiment, the token is a single-use token, and once presented to the merchant point-of-sale device 110 it will no longer be made available by the mobile device 108 for subsequent transactions.

Next, at block 406, the merchant point-of-sale device 110 transmits a payment authorization request including the token and the payment type indication to a payment authorization system 113. At block 408, the payment gateway module 112 detects the token as being a token for use with the mobile wallet registry system 100 instead of for direct transmission to a payment processor 116, and transmits a validation request including the token to a mobile token validation module 122. In some embodiments, the validation request may also include the payment type indication and/or other characteristics of the transaction, including the authorization amount, the merchant ID, the merchant category, and/or the like. In some embodiments, a unique Bank Identification Number (BIN) associated with the mobile wallet registry system 100 may be used to allow the payment gateway module 112 to detect that the transaction contains a token instead of a payment card account number. In some embodiments, other characteristics of the authorization request will indicate to the payment gateway module 112 that the authorization request includes a payment token. In some embodiments, the payment gateway module 112 may cause the authorization request from the merchant point-of-sale device 110 to enter a suspended state while communicating with the mobile wallet registry system 100. Next, at block 410, the mobile token validation module 122 retrieves a token record from the mobile token data store 124, the token record including a wallet ID and associated policy settings. The method 400 then proceeds to a continuation terminal (“terminal A”).

From terminal A (FIG. 4B), the method 400 proceeds to block 412, where the policy and fraud detection module 120 analyzes the validation request, and either approves or denies the request. As discussed above, the policy and fraud detection module 120 may analyze the validation request in accordance with previous patterns of behavior to determine whether or not the validation request is likely associated with a fraudulent transaction. If the request is determined to likely be fraudulent, the policy and fraud detection module 120 may inform the mobile token validation module 122, which may notify the payment gateway module 112 that the request was rejected. If the token validation request fails due to fraud indicators, the wallet registry system 100 may also notify the configuration portal server 102 that a token validation request associated with a particular wallet ID and payment type indicator failed due to fraud indicators. On the other hand, at block 414, in response to approval from the policy and fraud detection module 120, the mobile token validation module 122 transmits a request for payment account information to the configuration portal server 102. The request for payment account information may include the wallet ID and an indication of the payment type selection. The request for payment account information may include additional information, such as the funding amount requested, the merchant category, the merchant ID, and/or the like.

Next, at block 416, the configuration portal server 102 retrieves the payment account information associated with the request for payment account information from the sponsor wallet 104, and transmits the information to the mobile token validation module 122. In some embodiments, the configuration portal server 102 may perform additional security checks before providing the payment account information to the mobile token validation module 122. For example, in a situation where the mobile device 108 has been lost or stolen, the consumer may connect to the configuration portal server 102 via a web-based interface from a different device to disable the sponsor wallet 104. In that case, even if valid payment tokens reside on the mobile device 108, an unauthorized use of the payment account may be avoided by refusing to provide the payment information from the sponsor wallet 104.

Next, at block 418, the mobile token validation module 122 transmits the payment account information to the payment gateway module 112. At block 420, the payment gateway module 112 creates a payment authorization request based on the payment account information (or replaces the token in the suspended authorization request with the actual payment account information), and performs a transaction with an appropriate payment processor 116. As of block 420, the rest of the payment transaction may be similar to a traditional transaction in which the payment gateway module 112 had received the payment account information directly from the merchant point-of-sale device 110. For example, the payment authorization request may include the payment account information, the amount of the transaction, and any other pertinent data. The payment processor 116 may reply with an authorization response indicating the status of the request, such as accepted, declined, rejected, and/or the like, which is then transmitted to the merchant point-of-sale device 110 to complete the authorization transaction. The method 400 then proceeds to an end block and terminates.

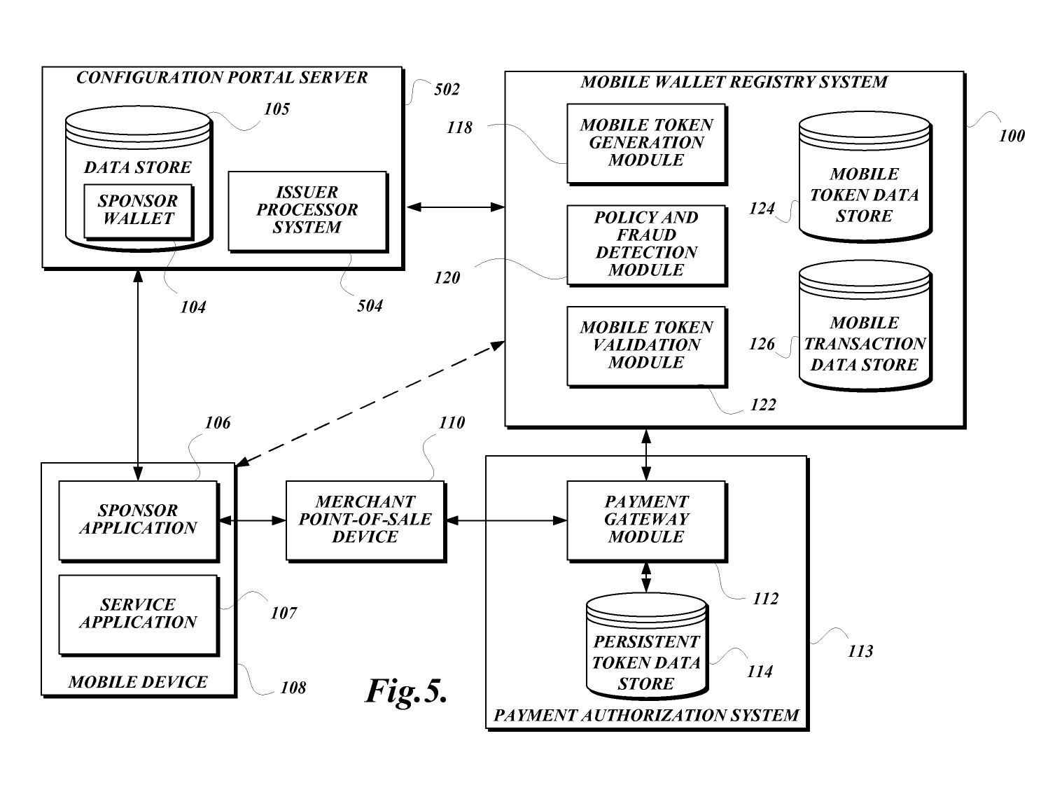

In some embodiments, the configuration portal server 102 may be operated by the party issuing the payment service to the consumer (i.e., a card issuer, a bank, an alternative payment service provider such as PayPal, and/or the like). An exemplary one of these embodiments is illustrated in FIG. 5. In such embodiments, the merchant point-of-sale device 110 may route an authorization request containing a payment token directly to the mobile wallet registry system 100 without using the payment gateway module 112. If there is a payment gateway module 112 present in this scenario, it may be transparent, or the authorization request may include information that indicates to the payment gateway module 112 that it should relay the authorization request to the mobile wallet registry system 100 rather than suspend the authorization request and send a token validation request to the mobile wallet registry system 100. The mobile wallet registry system 100 validates the token and, if successful, resolves the wallet ID associated with the token. The mobile wallet registry system 100 then relays the authorization request including the wallet ID, a specific indication of payment type, and other transaction details to the configuration portal server 502. The configuration portal server 502 resolves the specific sponsor wallet 104, evaluates the transaction request against a status of the consumer account represented by sponsor wallet 104, and returns an authorization request response to the mobile wallet registry system 100. In processing the authorization request, the configuration portal server 102 may work with other servers and subsystems maintained by the issuing sponsor, such as an issuer processor system 504, in order to evaluate and generate an appropriate response. In some embodiments, the issuer processor system 504 is similar to a payment processor 116 illustrated in FIG. 1, though in the embodiment illustrated in FIG. 5, the authorization request is transmitted to the issuer processor system 504 directly from the configuration portal server 502 instead of having to pass back through the mobile wallet registry system 100. The mobile wallet registry system 100 relays the authorization request response to the merchant point-of-sale device 110, either via a payment gateway module 112 or directly. In such embodiments, the entity operating the payment gateway module 112, the mobile wallet registry 100, or the configuration portal server 102 may provide settlement functions for the merchant, such as via the issuer processor system 504 or other suitable system. Similar to FIG. 1, as indicated by the dashed arrow in FIG. 5, in some embodiments the mobile device 108 may communicate directly with the mobile wallet registry system 100 instead of communicating through the configuration portal server 102 and/or the merchant point-of-sale device 110 to access various functionality described herein.

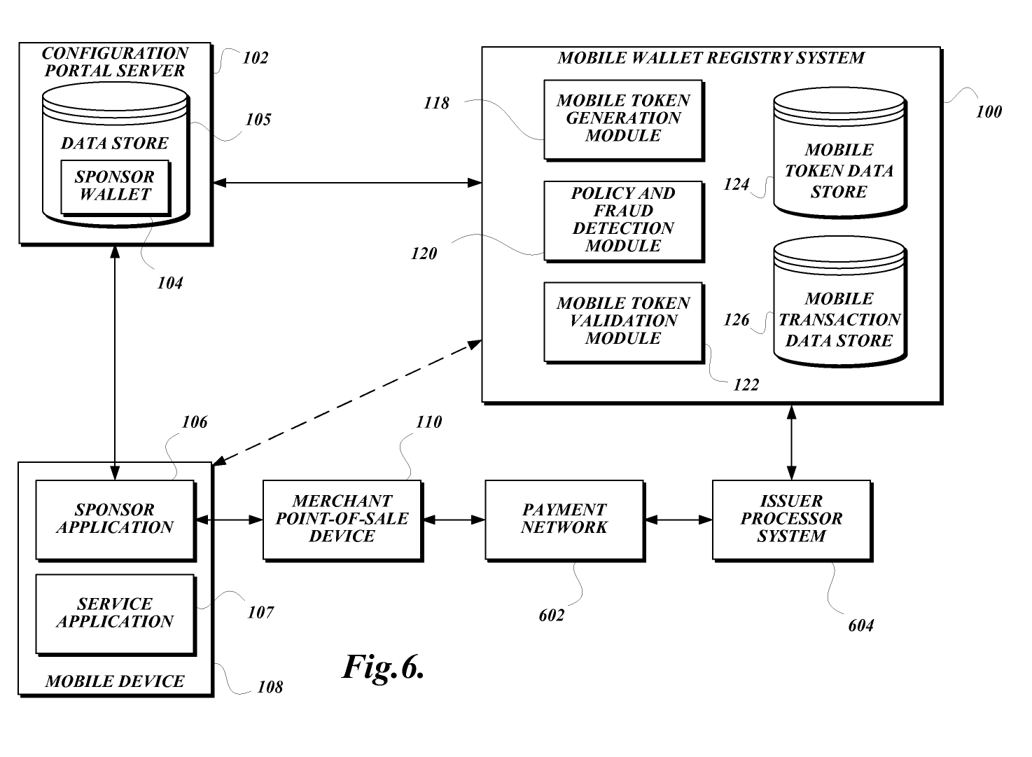

FIG. 6 illustrates another exemplary embodiment of a mobile wallet registry system 100 according to various aspects of the present disclosure. The mobile wallet registry system 100, the configuration portal server 102, the mobile device 108, and the merchant point-of-sale device 110 are configured and operate similarly to those illustrated in FIGS. 1 and 5 discussed above. However, instead of integration between the payment gateway module 112 and the mobile wallet registry system 100, the mobile wallet registry system 100 is integrated with an issuer processor system 604. An authorization request from the merchant point-of-sale device 110 is transmitted via a traditional payment network 602 to the appropriate issuer processor system 604. The payment network 602 may represent a traditional authorization system, such as a merchant acquirer processor and a card payment network, or it may represent an alternative payment network capable of transporting authorization requests from the merchant point-of-sale 110 to issuer processor systems 604 that are associated with alternative payment service providers, such as PayPal, automated clearinghouse (ACH) processing systems, and/or the like. The issuer processor system 604 detects that the authorization request includes a mobile token, and requests resolution of the wallet ID from the mobile wallet registry system 100. The wallet ID may provide the issuer processor system 604 with information usable to resolve the specific sponsor wallet 104 associated with the authorization request, and the issuer processor system 604 may return an authorization response to the merchant point-of-sale device 110 via the payment network 602 based on the status of the consumer account associated with the resolved sponsor wallet 104. In such embodiments, the issuer or the issuer's processor may also be operating a configuration portal server 102 and may capture the wallet ID associated with a sponsor wallet 104 during the initial configuration process. Again, as indicated by the dashed arrow, in some embodiments the mobile device 108 may communicate directly with the mobile wallet registry system 100 instead of communicating through the configuration portal server 102 and/or the merchant point-of-sale device 110 to access various functionality described herein.

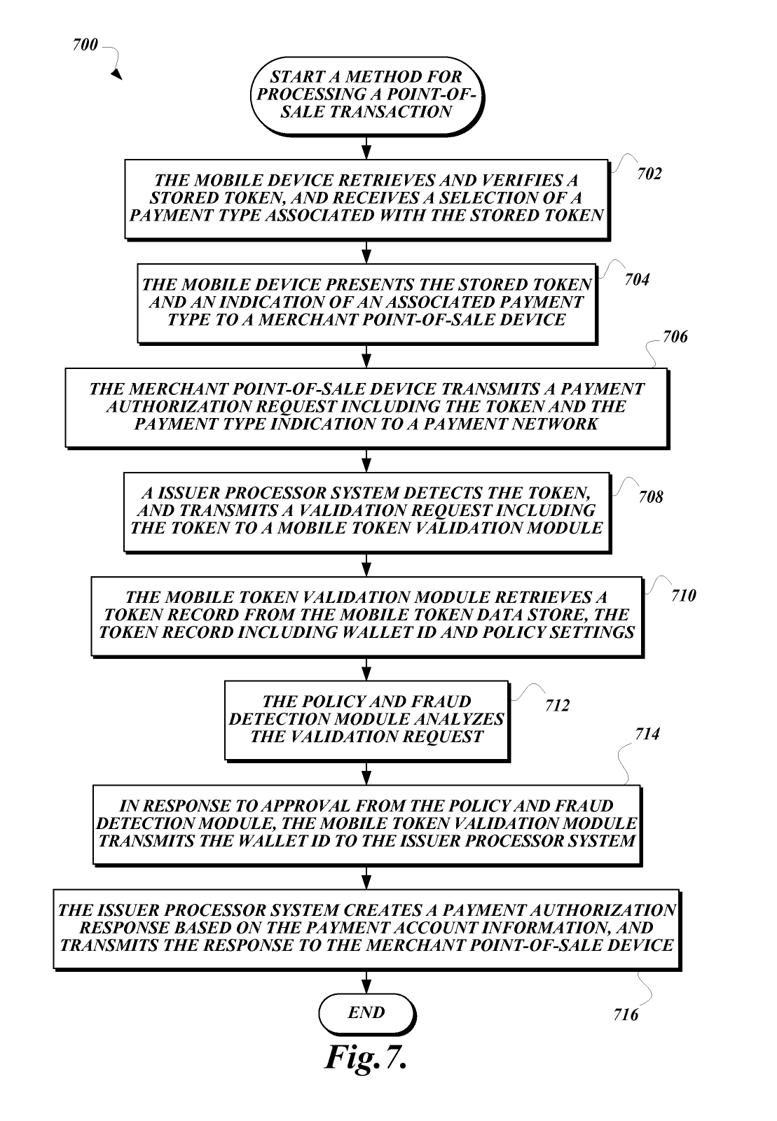

FIG. 7 illustrates another exemplary embodiment of a method 700 for processing a point-of-sale transaction according to various aspects of the present disclosure. The method 700 is a variation of the process illustrated in FIGS. 4A and 4B that may be used in embodiments such as that illustrated in FIG. 6. From a start block, the method 700 proceeds to block 702, where the mobile device 108 retrieves and verifies a stored token, and receives a selection of a payment type associated with the stored token. At block 704, the mobile device 108 presents the stored token and an indication of an associated payment type to a merchant point-of-sale device 110. In some embodiments, a proximity communications technique may be used to present the information to the merchant point-of-sale device 110. At block 706, the merchant point-of-sale device 110 transmits a payment authorization request including the token and the payment type indication to a payment network 602. One of ordinary skill in the art will understand that blocks 702-706 are similar to blocks 402-406 illustrated in FIG. 4A and described further above.

At block 708, the authorization request transaction (including the payment token) has traveled via the payment network 602, which may include one or more payment authorization networks (including, as applicable, a merchant acquirer or processor, a payment network, and/or the like) to the issuer processor system 604. The issuer processor system 604 detects the token at block 708 and transmits a validation request including the token to the mobile token validation module 122. The validation request may include other details associated with the authorization request, including date and/or timestamp, transaction identifiers, a funding amount requested, a merchant category, a merchant ID, and/or the like. Next, at block 710, the mobile token validation module 122 retrieves a token record from the mobile token data store 124, the token record including a wallet ID and associated policy settings. At block 712, the policy and fraud detection module 120 analyzes the request, and either approves or denies the request. As discussed above, the policy and fraud detection module 120 may analyze the validation request in accordance with previous patterns of behavior to determine whether or not the validation request is likely associated with a fraudulent transaction. If the request is determined to likely be fraudulent, the policy and fraud detection module 120 may inform the mobile token validation module 122, which may notify the issuer processor system 604 that the request is likely fraudulent. If the token validation request fails due to fraud indicators, the mobile wallet registry system 100 may also notify the issuer's configuration portal server 102 that a token validation request associated with the wallet ID and payment type indicator failed due to fraud indicators. On the other hand, at block 714, in response to approval from the policy and fraud detection module 120, the mobile token validation module 122 transmits the wallet ID (and indication of specific payment type, if applicable) to the issuer processor system 604. At block 716, the issuer processor system 604 resolves the underlying payment account from the appropriate sponsor wallet 104 represented by the wallet ID, creates a payment authorization response based on the payment account information, and transmits the response to the merchant point-of-sale device 110, thus completing the transaction. The issuer processor system 604 may analyze the authorization request against the status of the consumer account represented by sponsor wallet 104. The response may be transmitted via the payment network 602. The method 700 then proceeds to an end block and terminates.

Settlement of merchant transactions may be accomplished in a number of ways. In front-end integration scenarios, merchants may submit transactions for settlement using the information included within the authorization response (i.e., either the original payment token or a persistent token returned by the payment gateway function). These tokens may be translated by the payment gateway module 112 (possibly in conjunction with the mobile wallet registry system 100 and the configuration portal server 102) into the specific payment accounts they reference and submitted to payment processors and/or merchant acquirer(s) for settlement. In back-end integration scenarios, merchant settlement may be accommodated in at least two ways. In one scenario, merchants may submit their settlement requests via traditional techniques (including the payment tokens included within the authorization request responses), and those requests may be routed appropriately via payment networks just as the authorization requests are routed to the appropriate issuer. The issuer processor system 504 may directly process these settlement requests, or may repeat a transaction with the mobile wallet registry system 100 to resolve the wallet ID and specific payment type indicator associated with each settlement request. In another scenario, the issuer processor system 504 may capture all of the information required during the authorization process to settle transactions directly with the merchant (for example, in the absence of a separate merchant acquiring entity and/or payment network).

The embodiments highlighted herein enable merchants to process all of the transactions that they currently conduct with traditional card payments (authorizations, settlements, reversals, refunds, chargebacks, and/or the like), except that these transactions involve payment token references to accounts that are secured “in the cloud”, rather than using the specific account details to process the transactions.

The embodiments described above should be seen as exemplary, and not limiting. In other embodiments, additional features may be provided. For example, in one embodiment, the policy and fraud detection module 120 may provide a wallet policy API. The wallet policy API may allow the configuration portal server 102 to add, change, or delete mobile wallet policy settings on behalf of consumers. The policy settings may include, but are not limited to, token spending limits, time-to-live durations for issued tokens, and the like. The policy settings may apply universally to a given wallet ID, or may apply to one or more specific payment types associated with a particular wallet ID. In another embodiment, the policy and fraud detection module 120 may provide a policy event notification API. The policy event notification API allows the policy and fraud detection module 120 to alert the sponsor portal server 102 that a policy has been violated or that a fraud threshold has been exceeded, or in any other event in which the policy and fraud detection module 120 has detected possible fraudulent activity.

In other embodiments, the components illustrated and described above may have more or less capabilities than described. Though functions are described as being performed by particular portions of the disclosed system, in other embodiments, functions described as being performed by separate modules may be performed by a single module, or functions described as being performed by a single module may be performed by multiple modules. Further, components that have been illustrated as separate physical components, such as the configuration portal server 102 and the mobile wallet registry system 100, or the mobile wallet registry system 100 and the payment gateway module 112, may be managed by a single entity or may be combined into a single physical device. In another embodiment, the functionality of components illustrated as a single device may be provided by multiple physical devices and/or managed by multiple entities. Further, the different portions of the disclosed system may be operated by a single entity, or may be operated by two or more entities which each operate different portions of the overall system.

Various principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the invention in which an exclusive property or privilege is claimed are defined as follows:

1. A computing device configured to perform actions for processing a payment authorization request, wherein the actions comprise:
receiving, by the computing device from a merchant point-of-sale device, a payment authorization request, wherein the payment authorization request includes a payment token;
transmitting, by the computing device, a validation request to a mobile token validation module;
receiving, by the computing device, payment account information from the mobile token validation module in response to the validation request;
transmitting, by the computing device to a payment processor, a payment authorization request based on the payment account information; and
transmitting, by the computing device to the merchant point-of-sale device, a payment authorization response, the payment authorization response including a persistent token.

2. The computing device of claim 1, wherein the actions further comprise storing the persistent token in a persistent token data store.

3. The computing device of claim 1, wherein the payment authorization request and the validation request include an associated payment type, and wherein the payment account information is associated with the payment token and the associated payment type.

4. The computing device of claim 3, wherein the payment token is associated with a mobile wallet, wherein the mobile wallet stores payment account information associated with a plurality of payment accounts, and wherein the associated payment type is associated with a selected one of the plurality of payment accounts.

5. The computing device of claim 1, wherein the actions further comprise:
transmitting, by the computing device, a payment authorization response to the merchant point-of-sale device in response to a notification received from the payment processor.

6. The computing device of claim 5, wherein the payment authorization response includes a portion of the payment account information.

7. The computing device of claim 1, wherein the actions further comprise detecting the payment token as being for use with a mobile wallet registry system.

8. A system for managing mobile tokens, the system comprising:
a mobile token data store configured to store token records, each token record including a mobile token and an associated wallet identifier;
a mobile token validation module communicatively coupled to the mobile token data store and configured to:
receive a validation request from a requestor, the validation request including a mobile token and a payment type indication;
retrieve a wallet identifier associated with the mobile token from a token record in the mobile token data store;
retrieve payment account information from a configuration portal server using the mobile token and the payment type indication; and
transmit the payment account information to the requestor.

9. The system of claim 8, wherein the requestor is a payment gateway module.

10. The system of claim 8, wherein the requestor is an issuer processor system.

11. The system of claim 8, wherein the mobile token data store is configured to store a plurality of token records each including a different mobile token and a given associated wallet identifier.

12. The system of claim 8, wherein each token record includes addressing information.

13. The system of claim 8, further comprising a mobile token generation module configured to:
generate a token in response to a token request, the token request including a wallet identifier; and
store a token record including the token and the wallet identifier in the mobile token data store.

14. The system of claim 13, wherein the token request is received from a configuration portal server, and wherein the mobile token generation module is further configured to transmit the token to the configuration portal server.

15. The system of claim 13, wherein the token request is received from a mobile device, and wherein the mobile token generation module is further configured to transmit the token to the mobile device.

16. The system of claim 8, further comprising a policy and fraud detection module configured to enforce wallet policies and detect fraud patterns.

17. The system of claim 16, wherein wallet policies include one or more of a spending limit per token, a token expiration date, a token window, allowable merchant categories, and token velocity.

18. The system of claim 16, wherein the mobile token data store is further configured to store wallet policies.

19. A computer-implemented method for configuring and using a mobile wallet, the method comprising:
receiving, by a configuration portal server, a wallet boarding request from a requesting device, wherein the wallet boarding request includes a mobile device identifier;
creating, by the configuration portal server, a sponsor wallet in a sponsor wallet data store, the sponsor wallet including payment type information, payment account information, and the mobile device identifier;
transmitting, by the configuration portal server, policy setting information and payment type information to a mobile wallet registry system;
receiving, by the configuration portal server, a wallet identifier from the mobile wallet registry system; and
storing, by the configuration portal server, the wallet identifier in the sponsor wallet.

20. The computer-implemented method of claim 19, wherein the wallet boarding request includes the payment type information and the payment account information.

21. The computer-implemented method of claim 19, wherein the payment account information includes information associated with more than one payment account.

22. The computer-implemented method of claim 19, wherein the policy setting information includes multiple policies, and wherein each of the multiple policies is associated with at least one payment account identified in the payment account information.

23. The computer-implemented method of claim 19, wherein the policy setting information includes at least one policy that defines how a payment account identified in the payment account information is allowed to be used, wherein the at least one policy includes a threshold amount or a category of merchant.

24. The computer-implemented method of claim 19, further comprising, in response to receiving a token generation request from a mobile device, transmitting, by the configuration portal server to the mobile wallet registry system, a token request.

25. The computer-implemented method of claim 24, further comprising, in response to receiving a token from the mobile wallet registry system, transmitting, by the configuration portal server, the token to the mobile device.

26. The computer-implemented method of claim 19, further comprising, in response to receiving a token generation request from a mobile device, transmitting, by the mobile wallet registry system, the token to the mobile device.

27. The computer-implemented method of claim 19, further comprising:
receiving, by the configuration portal server, a request for payment account information from the mobile wallet registry system, the request for payment account information including a wallet identifier; and
transmitting, by the configuration portal server to the mobile wallet registry system, payment account information associated with the wallet identifier.

28. A system for managing mobile tokens, the system comprising:
a mobile token data store configured to store token records, each token record including a mobile token and an associated wallet identifier;
a mobile token validation module communicatively coupled to the mobile token data store and configured to:
receive a validation request from a requestor, the validation request including a mobile token and a payment type indication;
retrieve a wallet identifier associated with the mobile token from a token record in the mobile token data store;
transmit the wallet identifier to a configuration portal server;
receive a validation response created by an issuer processor system of the configuration portal server; and
transmit the validation response to the requestor.

29. The system of claim 28, wherein the requestor is a payment gateway module;

30. The system of claim 28, wherein the requestor is a merchant point-of-sale device.

31. The system of claim 28, wherein the mobile token data store is configured to store a plurality of token records each including a different mobile token and a given associated wallet identifier.

32. The system of claim 28, further comprising a mobile token generation module configured to:
generate a token in response to a token request received from a configuration portal server, the token request including a wallet identifier; and
store a token record including the token and the wallet identifier in the mobile token data store.

33. The system of claim 32, wherein the mobile token generation module is further configured to transmit the token to the configuration portal server.

34. The system of claim 32, wherein the mobile token generation module is further configured to transmit the token to a mobile device.

35. The system of claim 28, further comprising a policy and fraud detection module configured to enforce wallet policies and detect fraud patterns.

36. The system of claim 35, wherein wallet policies include one or more of a spending limit per token, a token expiration date, a token window, allowable merchant categories, and token velocity.

37. The system of claim 35, wherein the mobile token data store is further configured to store wallet policies.

38. A mobile device configured to use a mobile wallet, wherein the mobile device is configured to execute:
one or more sponsor applications; and
a service application; wherein the service application is configured to:
receive a request from a sponsor application to use a payment token associated with a payment type;
verify that the sponsor application is authorized to use the requested payment type; and
in response to determining that the sponsor application is authorized, provide the requested payment token for use by the sponsor application.

39. The mobile device of claim 38, wherein providing the requested payment token for use by the sponsor application includes transmitting the payment token to a merchant point-of-sale device.

40. The mobile device of claim 39, wherein transmitting the payment token to a merchant point-of-sale device includes transmitting the payment token to a merchant point-of-sale device using a proximity payment technique.

41. The mobile device of claim 39, wherein the service application is further configured to receive transaction information from the merchant point-of-sale device.

42. The mobile device of claim 41, wherein the transaction information includes one or more of an electronic receipt; a balance notification; a coupon; detailed transaction data; a selection of a payment type; and a transaction denial.

43. The mobile device of claim 38, wherein the service application is further configured to:
transmit a request for a payment token;
receive the payment token; and
store the payment token for use by one or more sponsor applications.

44. The mobile device of claim 43, wherein the request for a payment token is transmitted to a mobile wallet registry system.

45. The mobile device of claim 43, wherein the request for a payment token is transmitted to a configuration portal server.
